(19) United States
(12) Patent Application Publication
(10) Pub. No.: US 2026/0064055 A1
(43) Pub. Date: Mar. 5, 2026

(54) FIXING DEVICE AND IMAGE FORMING APPARATUS

(71) Applicant: KYOCERA Document Solutions Inc., Osaka (JP)

(72) Inventors: Yuta KITABAYASHI, Osaka (JP); Takashi EIKI, Osaka (JP); Hiroki KAWASAKI, Osaka (JP); Shunsaku FUJII, Osaka (JP); Yuto MASAOKA, Osaka (JP); Kenichi KASAMA, Osaka (JP); Takashi MIYAKE, Osaka (JP); Ryohei TOKUNAGA, Osaka (JP); Akihiro KONDO, Osaka (JP)

(73) Assignee: KYOCERA Document Solutions Inc., Osaka (JP)

(21) Appl. No.: 19/304,036

(22) Filed: Aug. 19, 2025

(30) Foreign Application Priority Data
Aug. 28, 2024 (JP) 2024-146504

(51) Int. Cl. G03G 15/20; H05B 3/03

(52) U.S. Cl. CPC G03G 15/2053; G03G 15/2064; H05B 3/03; G03G 2215/2035

(57) ABSTRACT

A fixing device includes a fixing belt, a pressure member, and a heater. The heater includes a plurality of resistance heating elements formed on one surface of a substrate at intervals in the axial direction. The resistance heating elements contain at least one first resistance heating element, and at least one second resistance heating element formed at a position displaced from the first resistance heating element on an upstream side or on a downstream side of the first resistance heating element in a medium conveyance direction orthogonal to the axial direction. A displacement amount between the first resistance heating element and the second resistance heating element is less than a dimension of the pressure region in the conveyance direction, and is set in a range of 0.1 mm or larger to less than 4.5 mm.

### INCORPORATION BY REFERENCE

This application is based on and claims the benefit of priority from Japanese patent application No. 2024-146504 Aug. 28, 2024, which is incorporated by reference in its entirety.

### TECHNICAL FIELD

The present disclosure relates to a fixing device which fixes a toner image on a medium and an image forming apparatus.

### BACKGROUND

There is known a fixing device which heats toner on a paper while passing the paper between a fixing belt and a pressure roller. A heating body extending in the axial direction of the fixing belt is brought into contact with the inner surface of the fixing belt. The heating body has a plurality of resistance heating elements formed on one surface of a substrate. The plurality of resistance heating elements are formed at positions displaced in a stepped manner in the short direction of the substrate.

It is presumed that the plurality of resistance heating elements described above are arranged in a stepped manner in consideration of wiring on the substrate. According to this configuration, it may be possible to make the heating body compact while securing the insulation distance (creepage distance) between adjacent resistance heating elements. However, when the resistance heating elements are thermally expanded by being powered, forces opposite to each other are exerted between the adjacent resistance heating elements, so that when the displacement of the resistance heating elements exceeds a certain amount, the substrate may be easily damaged.

### SUMMARY

A fixing device according to the present disclosure includes a fixing belt, a pressure member, and a heater. The fixing belt is formed in a cylindrical shape, and heats toner on a medium while rotating around an axis. The pressure member forms a pressure region between the fixing belt and the pressure member, and pressurizes the toner on the medium passing through the pressure region while rotating around an axis. The heater extends in an axial direction of the axis of the fixing belt, comes into contact with an inner surface of the fixing belt facing the pressure region, and heats the fixing belt. The heater includes a plurality of resistance heating elements formed on one surface of a substrate at intervals in the axial direction. The plurality of resistance heating elements contain at least one first resistance heating element, and at least one second resistance heating element formed at a position displaced from the first resistance heating element on an upstream side or on a downstream side of the first resistance heating element in a medium conveyance direction orthogonal to the axial direction. A displacement amount between the first resistance heating element and the second resistance heating element is less than a dimension of the pressure region in the conveyance direction, and is set in a range of 0.1 mm or larger to less than 4.5 mm.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to the embodiment of the present disclosure.

FIG. 3 is a cross-sectional view taken along the line III-III of FIG. 2.

FIG. 4 is a bottom view showing a heater of the fixing device according to one embodiment of the present disclosure.

### DETAILED DESCRIPTION

Hereinafter, with reference to the attached drawings, an embodiment of the present disclosure will be described. Fr, Rr, L, R, U and D shown in the drawings indicate front, rear, left, right, upper and lower. The front-and-rear direction (conveyance direction), the left-and-right direction (axial direction), and the upper-and-lower direction are orthogonal to each other. Although terms indicating direction and position are used herein, these terms are used for convenience of explanation and are not intended to limit the scope of the disclosure. The terms “upstream”, “downstream”, and the related terms refer to “upstream”, “downstream” in the conveyance direction of the paper P (medium), and the related concepts. In each of the figures, the dimensions and angles of the members are not accurate and are schematized for the sake of illustration.

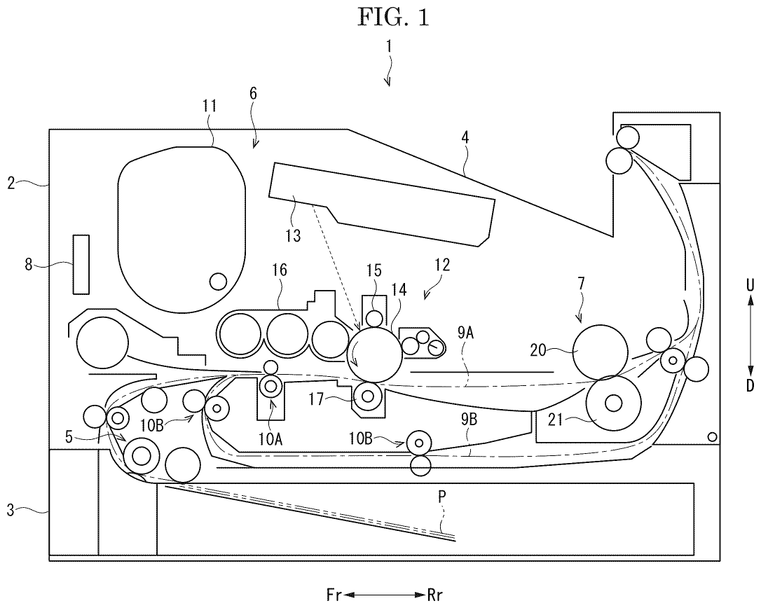

With reference to FIG. 1, an image forming apparatus 1 according to the present embodiment will be described. FIG. 1 is a schematic view (side view) showing the image forming apparatus 1.

The image forming apparatus 1 is an electrophotographic printer. The image forming apparatus 1 includes with an apparatus main body 2 constituting a substantially rectangular parallelepiped appearance. A paper feeding cassette 3 which stored a paper P (medium), for example, is detachably provided at the lower portion of the apparatus main body 2. A paper discharge tray 4 is provided on the upper surface of the apparatus main body 2. The paper P as an example of the medium is not limited to a paper but may be a resin sheet or the like.

The image forming apparatus 1 includes a paper feeding device 5, an image forming device 6, and a fixing device 7. The paper feeding device 5 is provided at the upstream end of a conveyance path 9A extending from the paper feeding cassette 3 to the paper discharge tray 4, and feeds the papers P stored in the paper feeding cassette 3 to the conveyance path 9A one by one. The image forming device 6 is provided in the intermediate portion of the conveyance path 9A and forms a toner image on the conveyed paper P. The fixing device 7 is provided on the downstream portion of the conveyance path 9A and thermally fixes the toner image to the paper P.

On the conveyance path 9A, a pair of registration rollers 10 which temporarily blocks the conveyed paper P and corrects the skew of the paper P (skew correction) is provided. An inversion conveyance path 9B is provided below the conveyance path 9A, which branches at the downstream portion of the conveyance path 9A and merges with the upstream portion of the conveyance path 9A. On the inversion conveyance path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

The image forming apparatus 1 is provided with a control device 8 for controlling the entire apparatus. The control device 8 may be configured by a processor or a logic circuit (hardware) formed in an integrated circuit or the like. In the case of the processor, the processor reads and executes programs stored in a memory to performs various processes.

[Image Forming Process] The control device 8 for controlling the image forming apparatus 1 performs an image forming process based on image data input from an external terminal as follows.

The charging device 15 charges the surface of the photosensitive drum 14, and the optical scanner 13 emits scanning light based on the image data to form an electrostatic latent image on the photosensitive drum 14. The developing device 16 develops the electrostatic latent image on the photosensitive drum 14 into a toner image using the toner replenished from the toner container 11. The paper feeding device 5 feeds the paper P one by one from the paper feeding cassette 3 to the conveyance path 9A. The paper P is conveyed along the conveyance path 9A, after the skew is corrected by the pair of registration rollers 10A, the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

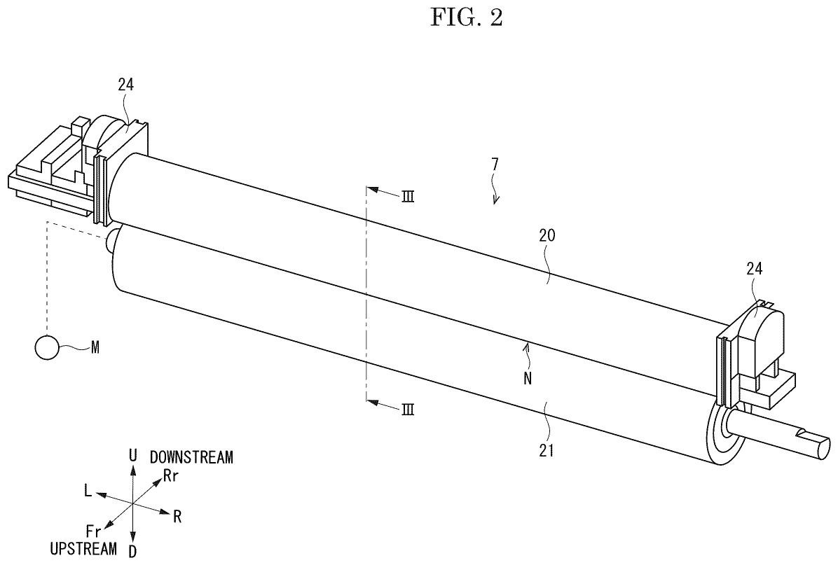

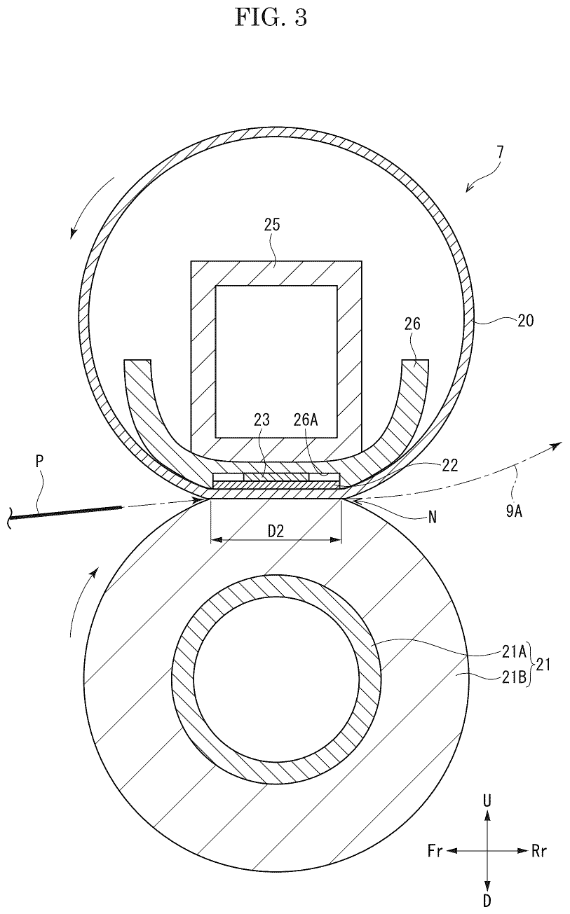

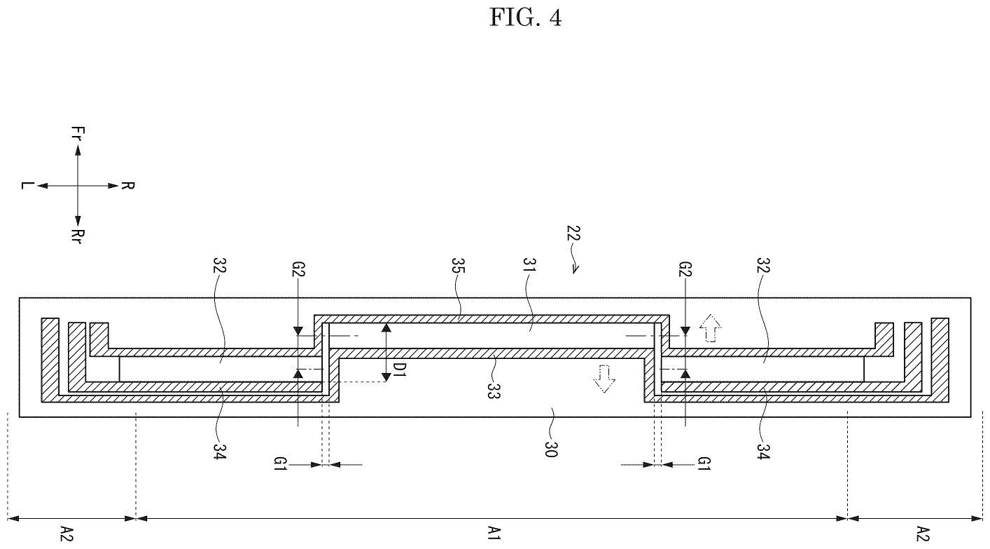

In the case of double-sided printing, the paper P which has passed through the fixing device 7 is switched back at the downstream end of the conveyance path 9A, and sent to the inversion conveyance path 9B. The paper P is conveyed by the pair of conveying rollers 10B, returned from the inversion conveyance path 9B to the conveyance path 9A again, and sent to the transfer nip after the skew correction by the pair of registration rollers 10A. Thereafter, the toner image is transferred to the paper P, and thermally fixed, and the double-sided printed paper P is discharged to the paper discharge tray 4.

[Fixing device] Next, the fixing device 7 will be described with reference to FIG. 2 to FIG. 4. FIG. 2 is a perspective view showing the fixing device 7. FIG. 3 is a cross-sectional view taken along the line III-III of FIG. 2. FIG. 4 is a bottom view showing a heater 22.

As shown in FIG. 2 and FIG. 3, the fixing device 7 includes a fixing belt 20, a pressure roller 21, a heater 22, and a heat equalizing member 23. The fixing belt 20 and the pressure roller 21 are supported by a frame (not shown), and the frame is fixed to the apparatus main body 2.

<Fixing Belt> The fixing belt 20 is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 2) are inserted into both right and left ends of the fixing belt 20. The pair of holding members 24 guide the fixing belt 20 rotatably around an axis while holding the fixing belt in a substantially cylindrical shape. The fixing belt 20 is supported by the frame via the pair of holding members 24 (not shown).

As shown in FIG. 3, an erection member 25 and a support member 26 are provided in a space surrounded by the fixing belt 20. The erection member 25 is made of, for example, metallic material such as stainless steel, and formed in a substantially rectangular cylindrical shape elongated in the left-and-right direction (axial direction), and is erected between the pair of holding members 24. The support member 26 is fixed to the lower portion of the erection member 25. The support member 26 is made, for example, of synthetic resin having heat resistance and wear resistance, and formed in a substantially semi-cylindrical shape elongated in the left-and-right direction. The support member 26 is curved along the inner surface of the fixing belt 20 and is in contact with the lower portion (the portion on the side of a pressure region N) of the inner surface of the fixing belt 20. A fitting portion 26A into which the heater 22 is fitted is recessed in the lower portion of the support member 26.

<Pressure Roller> As shown in FIG. 2 and FIG. 3, the pressure roller 21 as an example of the pressure member is formed in a substantially cylindrical shape elongated in the left-and-right direction. The pressure roller 21 has a metal core 21A and an elastic layer 21B such as a silicon sponge laminated on the outer peripheral surface of the metal core 21A (see FIG. 3). A drive motor M is connected to the left end of the metal core 21A via a gear train (not shown) (see FIG. 2). The pressure roller 21 comes into contact with the fixing belt 20 from the lower side and forms a pressure region N between the fixing belt 20 and the pressure roller 21. When the paper P passes through the pressure region N, the toner image is fixed on the paper P. The pressure region N refers to from an upstream position where the pressure is 0 Pa to a downstream position where the pressure is 0 Pa again via a position where the pressure acts.

The paper P is conveyed so that the center of the width in the left-and-right direction substantially coincides with the center of the pressure region N in the left-and-right direction (axial direction). For this reason, the fixing belt 20 (or the pressure region N) is provided with a passing region A1 which is the central region in the axial direction and is in contact with the paper P, and non-passing regions A2 which are the side end regions in the axial direction and are not in contact with the paper P (see FIG. 4). The paper P to be conveyed always comes into contact with the vicinity of the center region in the axial direction of the passing region A1, regardless of the size (dimension in the left-and-right direction) of the paper P. On the other hand, the paper P of a normal size (for example, A4 size) comes into contact with the regions on both sides of the passing region A1 in the axial direction, but the paper P of a small size (for example, A5 size, B5 size, or others) does not come into contact with the regions on both sides of the passing region.

<Heater> As shown in FIG. 3 and FIG. 4, the heater 22 extends in the left-and-right direction (axial direction) of the fixing belt 20, and is fitted into the fitting portion 26A of the support member 26. The heater 22 comes into contact with the inner surface of the fixing belt 20 facing the pressure region N, and heats the fixing belt 20. As shown in FIG. 4, the heater 22 includes a substrate 30 and a plurality of (for example, three) resistance heating elements 31, 32.

(Substrate) The substrate 30 is made of, for example, insulator (electrical insulating material) such as ceramic, and is formed in a substantially rectangular plate shape elongated in the left-and-right direction (axial direction). The axial dimension of the substrate 30 (the heater 22) is set equal to or smaller than the axial dimension of the fixing belt 20. The size of the substrate 30 in the front-and-rear direction (the conveyance direction) of the heater 22 is set equal to or less than the size (D2) (see FIG. 3) in the conveyance direction of the pressure region N.

(Resistance Heating Element) Each of the three resistance heating elements 31, 32 is made of metal material having a high electrical resistance value, and formed in a substantially rectangular shape. As shown in FIG. 4, the three resistance heating elements 31, 32 are formed on the lower surface (one surface) of the substrate 30 at intervals in the left-and-right direction (axial direction). One resistance heating element 31 is disposed on an axial central region of the substrate 30, and two resistance heating elements 32 are disposed on both axial side regions of the substrate 30 with gaps G1 from the central region. In this specification, for convenience of explanation, the one resistance heating element 31 disposed on the axial central region is referred to as “the first resistance heating element 31”, and the two resistance heating elements 32 disposed on both the side axial regions are referred to as “the second resistance heating element 32”. The gap G1 is set to an insulation distance (creepage distance) capable of preventing creeping discharge between the adjacent resistance heating elements 31, 32.

The first resistance heating element 31 is shorter than the second resistance heating element 32 in the left-and-right direction (axial direction). As will be described later in detail, the heater 22 includes three resistance heating elements 31, 32 for efficiently heating the papers P of a plurality of sizes. The first resistance heating element 31 corresponds to the left-and-right width of the small-size paper P, and all the resistance heating elements 31, 32 correspond to the left-and-right width of the normal-size paper P. Further, the three resistance heating elements 31, 32 are arranged in a stepped manner in consideration of, for example, wiring (individual electrodes 33, 34 to be described later) on the substrate 30. Specifically, the second resistance heating elements 32 are formed at positions displaced from the first resistance heating element 31 to one side (for example, on the downstream side (rear side)) in the conveyance direction. By arranging the three resistance heating elements 31, 32 in a stepped manner, the heater 22 can be made compact while securing the insulation distance (creepage distance) between the adjacent resistance heating elements 31, 32. An displacement amount G2 between the first resistance heating element 31 and the second resistance heating elements 32 indicates an interval between the center of the first resistance heating element 31 in the conveyance direction and the centers of the second resistance heating elements 32 in the conveyance direction. The displacement amount G2 is set to an insulation distance (creepage distance) capable of preventing creeping discharge between the adjacent resistance heating elements 31, 32.

The left-and-right (axial) dimension of the three resistance heating elements 31, 32, in other words, the dimension between the axial ends of the two second resistance heating elements 32, are set shorter than the axial total length of the fixing belt 20 and longer than the passing region A1 of the fixing belt 20 in the axial direction. That is, both axial side portions of the two second resistance heating elements 32 faces the non-passing regions A2 of the fixing belt 20. Further, the dimension of the three resistance heating elements 31, 32 in the front-and-rear direction (conveyance direction), that is, the dimensions (D1) between both ends of the first resistance heating element 31 and the second resistance heating element 32 in the conveyance direction (see FIG. 4), is set to be equal to or less than the dimension (D2) of the pressure region N in the conveyance direction (see FIG. 3).

As shown in FIG. 4, three individual electrodes 33, 34 and a common electrode 35 are formed on the lower surface of the substrate 30. The three individual electrodes 33, 34 and the common electrode 35 are made of, for example, metal material having an electrical resistance lower than that of the resistance heating elements 31, 32. The individual electrode 33 is connected to the downstream end (rear end) of the first resistance heating element 31, and the other individual electrodes 34 are connected to the downstream ends of the second resistance heating elements 32. The common electrode 35 is connected to the upstream ends (front ends) of all the resistance heating elements 31, 32. The individual electrodes 33, 34 and the common electrode 35 extend toward both sides in the axial direction of the substrate 30 from portions connected to the resistance heating elements 31, 32, respectively. The individual electrodes 33, 34 and the common electrode 35 are electrically connected to a device (not shown) such as a power source on both sides of the substrate 30 in the axial direction.

The resistance heating elements 31, 32, the individual electrodes 33, 34, and the common electrode 35 are covered with a coating layer (not shown). The heater 22 is fitted into the fitting portion 26A of the support member 26 and brings the coating layer into contact with the inner surface of the fixing belt 20. When the heater 22 receives the fixing belt 20 pressed against the pressure roller 21, the pressure region N is formed at a contact portion between the fixing belt 20 and the pressure roller 21. When the electric power supplied from the power source is applied to the respective resistance heating elements 31, 32 in the conveyance direction (short direction), the respective resistance heating elements 31, 32 generate heat. The fixing device 7 is provided with a temperature detection part (not shown) for detecting the temperature of the heater 22. The heater 22, the drive motor M, and the temperature detection part are electrically connected to the control device 8, a power supply (not shown), and the others. The control device 8 appropriately controls the power source, the heater 22, and the others.

<Heat equalizing member> In the fixing device 7 according to the present embodiment, the heater 22 is provided with the heat equalizing member 23 (see FIG. 3) in order to suppress excessive temperature rise at both end portions in the axial direction of the passing region A1 where the paper P does not pass and at the non-passing region A2. The heat equalizing member 23 is made of, for example, metal material such as aluminum alloy, and formed in a substantially rectangular plate shape. The heat equalizing member 23 is elongated in the axial direction so as to be equal to or smaller than the dimension of the heater in the left-and-right direction (axial direction). The heat equalizing member 23 is into contact with the upper surface of the heater 22 (the substrate 30) on the opposite side of the fixing belt 20 (the pressure region N), and is supported by the support member 26 (see FIG. 3). The heat equalizing member 23 absorbs the heat generated from the heater 22 and moves it in the axial direction to equalize the temperature of the heater 22 in the axial direction. As a result, the temperature of the fixing belt 20 is also substantially uniform in the axial direction, and excessive temperature rise in the non-passing region A2 is suppressed.

[Fixing Process] Here, the operation (fixing process) of the fixing device 7 will be described. The control device 8 controls the drive motor M to rotate the pressure roller 21 around the axis. The fixing belt 20 rotates in accordance with the pressure roller 21 (see the arrow in FIG. 3). The control device 8 receives a detection signal from the temperature detection part and controls the heater 22 (or the power source) so as to maintain a preset target temperature. The resistance heating elements 31, 32 of the heater 22 generate heat by being powered, and heat the fixing belt 20 (pressure region N).

At this time, the control device 8 changes the three resistance heating elements 31 and 32 for heating (being powered) according to a size of the paper P. For example, when the paper P of a normal size passes through the pressure region N, the control device 8 executes control for heating all the resistance heating elements 31, 32. When the paper P of a small size passes through the pressure region N, the control device 8 executes control for heating one resistance heating element 31. Thus, only a necessary area of the fixing belt 20 (pressure region N) can be heated in accordance with the size of the paper P. As a result, the power used can be kept to a minimum. It is also possible to suppress excessive temperature rise at both the axial end portions of the fixing belt 20.

When the temperature of the fixing belt 20 (heater 22) reaches the target temperature, the control device 8 starts the image forming process already described. The paper P on which the toner image is transferred enters the pressure region N. The fixing belt 20 heats the toner (toner image) on the paper P passing through the pressure region N while rotating around the axis. The pressure roller 21 pressurizes the toner on the paper P passing through the pressure region N while rotating around the axis. Then, the toner image is fixed to the paper P, and a fixed image is formed on the paper P. The paper P on which the image is fixed is discharged to the paper discharge tray 4.

[Displacement Amount of Adjacent Resistance Heating Elements] Since the resistance heating elements 31, 32 generate heat and thermally expand on the substrate 30, opposing forces may act between the adjacent resistance heating elements 31, 32 (see the dashed arrow in FIG. 4 (in FIG. 4, only the right side is shown)). As described above, the second resistance heating elements 32 are displaced downstream from the first resistance heating element 31, but when the displacement amount G2 becomes a certain value or more, the opposing forces caused by the thermal expansion of the resistance heating elements 31, 32 may cause damage to the substrate 30 such as the occurrence of cracks. Therefore, in the fixing device 7 according to the present embodiment, the displacement amount G2 between the first resistance heating element 31 and the second resistance heating element 32 is set to be less than the dimension (D2) of the pressure region N in the conveyance direction, and in the range of 0.1 mm or larger to less than 4.5 mm. In FIG. 4, the arrows indicating the opposing forces are shown in the directions along the conveyance direction, but precisely, since the resistance heating elements 31, 32 are thermally expanded in all directions (axial direction and conveyance direction) on the plane, the opposing forces are also directed in various directions on the plane. As described above, since the opposing forces are directed in various directions on the plane, it is presumed that complex forces act on the substrate 30 between the adjacent resistance heating elements 31, 32.

In the fixing device 7 according to the present embodiment described above, the second resistance heating element 32 is formed at a position displaced from the first resistance heating element 31 to one side (downstream) in the conveyance direction. The displacement amount G2 between the first resistance heating element 31 and the second resistance heating element 32 is less than the dimension of the pressure region N in the conveyance direction, and is set in a range of 0.1 mm or larger to less than 4.5 mm. Applicant has estimated through experiments that the range of the displacement amount G2 is effective in reducing the opposing forces acting between the adjacent resistance heating elements 31, 32 when the heater 22 is in operation. Thus, the damage of the substrate 30 caused by the thermal expansion of the resistance heating elements 31, 32 can be effectively suppressed.

In the fixing device 7 according to the present embodiment, the heater 22 includes three resistance heating elements 31, 32, but it is not limited to this, and may include two or more resistance heating elements 31, 32. The heater 22 includes one first resistance heating element 31 and two second resistance heating elements 32, but the present disclosure is not limited thereto. The heater 22 may include, for example, two or more first resistive heating elements 31 and one or more second resistive heating elements 32 (not shown). In this case, the three or more resistance heating elements 31, 32 may be arranged in a single step or a staggered shape (not shown).

In the heater 22 of the fixing device 7 according to the present embodiment, although the second resistance heating element 32 is formed at a position displaced from the first resistance heating element 31 to the downstream side in the conveyance direction, it is not limited thereto, and may be formed at a position displaced from the first resistance heating element 31 to the upstream side in the conveyance direction (not shown).

In the fixing device 7 according to the present embodiment, the paper P passes through the center of the pressure region N in the axial direction, but the paper P may pass through a position closer to one side of the pressure region N in the axial direction (not shown). In this case, the non-passing region A2 is set only on one side in the axial direction of the fixing belt 20 (or the pressure region N).

In the fixing device 7 according to the present embodiment, although the pressure roller 21 is rotationally driven to rotate and the fixing belt 20 is driven to be rotated accordingly, the fixing belt 20 may be rotationally driven to rotate and the pressure roller 21 may be rotated accordingly.

In the description of the above embodiment, the present disclosure is applied to the monochrome image forming apparatus 1 as an example, but the present disclosure is not limited to this, and may be applied to, for example, a color printer, a copying machine, a facsimile machine, a multifunctional peripheral, or the others.

It should be noted that the description of the above embodiments shows one aspect of the fixing device and the image forming apparatus according to the present disclosure, and the technical range of the present disclosure is not limited to the above embodiments. The disclosure may be variously modified, substituted or modified without departing from the spirit of the technical thought, and the claims include all embodiments which may be included within the scope of the technical thought.

1. A fixing device comprising:
a fixing belt which is formed in a cylindrical shape and heats toner on a medium while rotating around an axis;
a pressure member which forms a pressure region between the fixing belt and the pressure member, and pressurizes the toner on the medium passing through the pressure region while rotating around an axis; and
a heater which extends in an axial direction of the axis of the fixing belt, comes into contact with an inner surface of the fixing belt facing the pressure region, and heats the fixing belt, wherein
the heater includes a plurality of resistance heating elements formed on one surface of a substrate at intervals in the axial direction,
the plurality of resistance heating elements contain:
at least one first resistance heating element, and
at least one second resistance heating element formed at a position displaced from the first resistance heating element on an upstream side or on a downstream side of the first resistance heating element in a medium conveyance direction orthogonal to the axial direction, and
a displacement amount between the first resistance heating element and the second resistance heating element is less than a dimension of the pressure region in the conveyance direction, and is set in a range of 0.1 mm or larger to less than 4.5 mm.

2. An image forming apparatus comprising the fixing device according to claim 1.
